(19) United States
(12) Patent Application Publication
(10) Pub. No.: US 2019/0331277 A1
(43) Pub. Date: Oct. 31, 2019

(54) CONNECTORS FOR THERMOPLASTIC TUBE SEGMENTS AND METHOD

(71) Applicant: LE GROUPE DSD INC., Thetford Mines (CA)

(72) Inventor: Leandre VACHON, Thetford Mines (CA)

(73) Assignee: LE GROUPE DSD INC., Thetford Mines (CA)

(21) Appl. No.: 16/394,940

(22) Filed: Apr. 25, 2019

(30) Foreign Application Priority Data
Apr. 25, 2018 (CA) 3002715

(51) Int. Cl. F16L 47/06; F16L 25/14; B29C 65/00

(52) U.S. Cl. CPC F16L 47/06; F16L 25/14; F16L 2201/40; B29C 66/5229; B29C 66/5221

(57) ABSTRACT

The connector (200) can join an end of a first flexible thermoplastic tube segment (202) to an end of at least a second flexible thermoplastic tube segment (202). The connector (200) is made of a thermoplastic material allowing, through heat fusion, to join the inner surface (244) of the receptacles (240, 260) of the connector (200) to the outer surface (206) of the corresponding tube segments (202), and this, without creating a gap or an irregularity inside the portion of the liquid circuit. The heat fusion can result in airtight and robust joints made with a high precision and that are uniform, even if they can be made under difficult conditions. The proposed concept can be particularly useful in sugar making.

### CROSS-REFERENCE TO RELATED APPLICATION

The present case claims the benefit of Canadian patent application No. 3,002,715 filed on 25 Apr. 2018, which application is hereby incorporated by reference in its entirety.

### TECHNICAL FIELD

The technical field relates generally to the coupling of thermoplastic tube segments to create a tubing network for transporting liquids.

### BACKGROUND

Maple sugaring refers generally to the harvesting and the transformation of sap from trees, particularly from sugar maples, into various products. Many species of trees have a sap with a high sugar content and from which various products like those made using sugar maple sap can be made, for instance yellow birch, cherry birch, hickory, basswood, etc. However, sugar maples are more common.

A sugar bush is a wooded area where there are many sugar maples or the like, and where it is possible to harvest sap from these trees during some parts of the year, particularly at spring. The sap is harvested by drilling a hole in the trunk of a tree and by installing a corresponding spout through which the sap will flow under suitable weather conditions.

The most efficient way of collecting sap, and that is also the least invasive or damaging for the trees, is to use a tap hole having a relatively small diameter and a corresponding spout that is connected to a tubing network operating at a negative pressure, i.e. at a pressure below the ambient atmospheric pressure. The negative pressure creates a suction effect moving the sap more efficiently compared to using gravity alone. The sap transported through the conduits goes afterwards into a sap-processing plant, a reservoir, a tank or any other suitable location. Each tree from which its sap is harvested is then connected to the tubing through a series of tube segments coupled at various junctions and progressively increasing in diameter in the downstream direction.

The installation, the exploitation and the maintenance of a tubing network is a task that is often prone to problems and challenges. Among other things, the sheer number of junctions requires an extensive workforce and a substantial upfront investment, especially for medium- and large-scale facilities. The workers will often have to carry out operations under difficult conditions, particularly because of the usual cold and wet environment during the harvest season. A junction must be installed everywhere the ends of two or more tube segments must be coupled.

Flexible collars with a screw-type clamp or other kinds of hardware and devices are used for tightening the sidewall at each end of the tube segments to a corresponding conventional connector because the forced frictional engagement alone is generally not sufficient. These collars or the like are required for obtaining an airtight connection and for preventing the parts from accidentally detaching under normal traction forces. This technique requires a very intensive handling and the installation procedure is relatively slow and tedious. A junction can easily be improperly made if the worker is not negligent or was distracted at a given moment, or because the person lacks craftsmanship. This can be a concern, particularly when the interior of a tubing is under a negative pressure. An inadequate sealing is likely to create micro-leaks, namely small channels through which ambient air will continuously penetrate inside the tubing. In the context of maple sugaring, micro-leaks can cause the sap to freeze even if the ambient temperature is above the freezing temperature because in each micro-leak, the air undergoes an expansion resulting from the pressure gradient between the atmospheric pressure and the lower pressure in the tubing. This air expansion lowers the air temperature when it reaches the interior of the tubing. Micro-leaks also increase the difficulties in maintaining a suitable negative pressure inside the tubing when too many junctions are not perfectly airtight. The likelihood of encountering problems is generally proportional to the scale of the facility. Furthermore, it is often difficult to find where micro-leaks occur and, sometimes, if there are too many, the installation of a new tubing can be necessary, even if it was only recently installed. Defective junctions can also lead to a separation of a junction.

There are several kinds of plastic connectors on the market that can be inserted inside the ends of tube segments to be joined. However, they can significantly reduce the inner diameter at the junctions, and this may cause a sizable local restriction slowing down the liquid flow. They can also create discontinuities inside the liquid circuit. For instance, many conventional connectors create inner zones having a larger diameter between the end surfaces of the tube segments therein. These wider zones can allow dirt and bacteria to accumulate. Dirt and bacteria can also accumulate where there are restrictions in the liquid circuit. All these locations are generally difficult to clean without disassembling the tubing, thus removing the connectors from the tube segments.

Ice may form in the tubing even if there are no micro-leaks since sugar maple sap will freeze as soon as the ambient temperature falls well below the freezing temperature. When the ambient temperature increases enough for allowing the frozen sap to melt, some partially frozen sap fragments can start moving inside the tubing due to the negative pressure exerted downstream or because they are pushed by some liquid from an upstream location. Any gap or irregularity within the tubing can slow down or even block frozen sap fragments. A thaw is often a very good time for harvesting sap and any obstruction to the flow will slow down the collection process.

There are on the market various types of connectors made of stainless steel that can be inserted through the ends of the tube segments and that are only slightly decreasing the inner diameter. These connectors are, however, relatively costly and require that the ends of the tube segments be softened by heat for enabling their insertion on the connectors because they generally have the same or nearly the same outer diameter. Collars or the like are still necessary to fully secure the tube segments to the connectors because the forced frictional fit alone in not sufficient. The installation process is still relatively slow and tedious. Moreover, stainless steel connectors generally yield satisfactory results when the interior of the tubing is under a positive pressure but not under a negative pressure. Micro-leaks are very likely to occur under a negative pressure and, among other things, this can cause the sap to freeze inside the tube segments even when the ambient temperature is above freezing, as aforesaid.

Overall, there is still room for many improvements in the related technical area.

### SUMMARY

The proposed approach consists in joining the ends of flexible thermoplastic tube segments using an intervening thermoplastic connector that can be heat fused on these ends to form each junction. This approach greatly facilitates and speeds up the installation process of a tubing network. The resulting junctions can very easily be uniform, airtight and robust. Connectors of various sizes can be provided, thereby allowing different sizes of tube segments to be connected. These connectors can also be used for the transitions between tube segments of unequal diameters.

The number of tube segments that can be attached to each connector can vary from one implementation to another. This number is generally two or three. Variants are possible. For instance, a connector can join more than three tube segments. Some connectors can also be designed to fit only a single end of a tube segment, for instance at the upstream end of a branch in the tubing. In all instances, the connectors can be designed to avoid creating an internal gap or an irregularity along the liquid circuit against which the frozen sap fragments could impinge, or even be blocked by them. Furthermore, one can design the tubing network so that the only dimensional changes along the liquid circuit increases in the cross section area, for instance only diameter increases in the downstream flow direction. The absence of discontinuities and restrictions along the liquid circuit can also prevent dirt and bacteria to accumulate at such locations. It also maximizes the flow of liquid.

The approach proposed in the present invention has many additional advantages. Among other things, the mechanical strength of the junctions is greatly improved compared to that of previous connectors requiring collars or other similar devices. This allows increasing the traction forces subjected to the tubing, for instance to install a portion of the tubing with a relatively higher tension to prevent long suspended stretches of tube segments from sagging. Sagging can cause some liquid to stagnate or fail to flow optimally and the possibility of increasing the tension can be an important benefit in many implementations. This increased mechanical strength can also be advantageous for other reasons, for instance in implementations where a large number of tube segments are preassembled at a first site before being transported to a second site where they will be used. The preassembled tube segments then form a bundle. The resulting bundle may, however, be difficult to handle and carry, and it is sometimes simpler or necessary to drag it over the ground, for instance using a vehicle. Having an increased mechanical strength reduces the risks of failure of some of the junctions during the transportation. This can even allow larger bundles to be made compared to the previous connectors. The exterior of the connectors is preferably having rounded off edges to minimize the risks of accidentally wedging the connectors when the bundle is dragged on the ground. This can also mitigate damages to the trees, particularly their roots and the lower sections of their trunks.

Various connectors can be used to simplify the installation and the maintenance of a tubing network by heat fusing the outer surface at the end of a tube segment to the inner surface of a receptacle of the connector. The heat-fused junctions provide an enhanced sealing and solidity compared to that of previous methods. They can easily be made on a remote site, even deep into a forest, using a portable apparatus designed for this purpose.

The thermoplastic material of the tube segments and that of the connectors should have similar properties, for instance similar melting temperatures. It is generally preferable that the fused parts be made of a same thermoplastic material. Nevertheless, using different materials remains possible in some implementations.

The heat fusion creates an airtight and solid junction. The joints can be made with a high precision and uniformity, even under difficult conditions, thus regardless of the terrain, the weather conditions, etc. No special technical skills are required for creating these junctions.

Moreover, the heat fusion only uses the plastic materials of the parts to be attached. No glue or other chemical products are necessary, which can be very advantageous for facilities having or seeking out an organic certification.

In one aspect, there is provided a tube segment assembly including: a first flexible thermoplastic tube segment having an upstream end and a downstream end; a second flexible thermoplastic tube segment having an upstream end and a downstream end; an intervening thermoplastic connector having a central longitudinal axis, the connector including: a central part having an outer surface and an inner surface that are generally smooth and circular in cross-section, the central part being longitudinally delimited by opposite first and second edges, the first edge having an inner diameter and the second edge having an inner diameter; a first receptacle coaxially disposed with reference to a side of the central part that is adjacent to the first edge, the first receptacle including a generally smooth inner surface having an inner diameter that is larger than that of the first edge to define a first annular inner surface; and a second receptacle coaxially disposed on another side of the central part that is adjacent to the second edge, the second receptacle including a generally smooth inner surface having an inner diameter that is larger than that of the second edge to define a second annular inner surface; wherein: the first tube segment has an inner surface and an outer surface, the inner surface of the first tube segment having an inner diameter corresponding to the inner diameter of the first edge of the central part, the outer surface of the first tube segment having an outer diameter corresponding to the inner diameter of the inner surface of the first receptacle, the outer surface at the downstream end of the first tube segment being heat fused with the inner surface of the first receptacle at a first heat-fused joint; and the second tube segment has an inner surface and an outer surface, the inner surface of the second tube segment having an inner diameter corresponding to the inner diameter of the second edge of the central part, the outer surface of the second tube segment having an outer diameter corresponding to the inner diameter of the inner surface of the second receptacle, the outer surface at the upstream end of the second tube segment being heat fused with the inner surface of the second receptacle at a second heat-fused joint.

In another aspect, there is provided a method of joining corresponding ends of flexible thermoplastic tube segments using an intervening thermoplastic connector having at least two receptacles, the method including: generating heat on a portable apparatus; transferring the generated heat to a male die provided on the apparatus; transferring the generated heat to a female die; inserting the male die in a corresponding one of the receptacles for surface heating an inner surface to a temperature close to the melting point of the thermoplastic; inserting the end of one of the tube segments into the female die for surface heating an outer surface of the corresponding tube segment to a temperature close to the melting point of the thermoplastic; moving away the heated receptacle and the heated end of the corresponding tube segment from the dies, then inserting them into one another until an annular end surface of the corresponding tube segment abuts against an annular inner surface of the heater receptacle; and then cooling the heated receptacle and the heated end of the corresponding tube segment until a heat-fused joint is formed.

In another aspect, there is provided a tube segment assembly as disclosed, shown and/or suggested herein.

In another aspect, there is provided a connector as disclosed, shown and/or suggested herein.

In another aspect, there is provided a method of coupling two tube segments as disclosed, shown and/or suggested herein.

In another aspect, there is provided an apparatus for coupling two tube segments as disclosed, shown and/or suggested herein.

Further details on these aspects as well as other aspects of the proposed concept will be apparent from the following detailed description and the appended figures.

### BRIEF DESCRIPTION OF THE FIGURES

FIG. 1 is a semi-schematic view depicting a simplified example of a facility for harvesting sap from trees.

FIG. 2A is a semi-schematic view of a flexible thermoplastic tube segment.

FIG. 2B is a semi-schematic isometric view of two tube segments to be joined using a connector.

FIG. 3A is an isometric view of an example of a straight connector.

FIG. 3B is a side view of the connector in FIG. 3A.

FIG. 3C is a front view showing one of the receptacles of the connector in FIG. 3A.

FIG. 3D is a longitudinal cross-section view of the connector in FIG. 3A.

FIG. 3E is an enlarged view of what is shown in FIG. 3D that also shows the relative position between the ends of the two tube segments to be attached using the connector.

FIG. 4A is a first isometric view of another example of a straight connector.

FIG. 4B is a second isometric view of the connector in FIG. 4A.

FIG. 4C is a side view of the connector in FIG. 4A.

FIG. 4D is a longitudinal cross-section view of the connector in FIG. 4A.

FIG. 4E is an enlarged view of what is shown in FIG. 4D.

FIG. 5A is an isometric view of an example of a connector having a 90-degree elbow.

FIG. 5B is a side view of the connector in FIG. 5A.

FIG. 5C is a front view showing one of the receptacles of the connector in FIG. 5A.

FIG. 5D is a transversal cross-section view of the connector in FIG. 5A.

FIG. 6A is an isometric view of an example of a Y-shaped connector.

FIG. 6B is a side view of the connector in FIG. 6A.

FIG. 6C is a longitudinal cross-section view of the connector in FIG. 6A.

FIG. 6D is an oblique transversal cross-section view of the connector in FIG. 6A.

FIG. 7A is an isometric view of an example of a T-shaped connector.

FIG. 7B is a side view of the connector in FIG. 7A.

FIG. 7C is a top view of the connector in FIG. 7A.

FIG. 7D is a longitudinal cross-section view of the connector in FIG. 7A.

FIG. 8A is a first isometric view of an example of an end plug.

FIG. 8B is a second isometric view of the plug in FIG. 8A.

FIG. 8C is a side view of the plug in FIG. 8A.

FIG. 8D is a front-end view showing the receptacle of the plug in FIG. 8A.

FIG. 8E is a longitudinal cross-section view of the plug in FIG. 8A.

FIG. 9 is a semi-schematic view of an example of a portable apparatus for coupling the ends of two thermoplastic tube segments.

FIG. 10A is a cross-section view of an example of a male die provided on the apparatus for heating the inner surface of one of the receptacles of the connector.

FIG. 10B is a cross-section view of an example of a female die provided on the apparatus for heating the outer surface at the end of the tube segment.

FIG. 11A is a cross-section view of an example of a tube segment assembly in which a first and a second tube segment are rigidly attached through an intervening connector.

FIG. 11B is a semi-schematic view in which a third tube segment is rigidly attached the connector of FIG. 7D.

FIG. 12 is a side view an example of a support for the portable apparatus.

### DETAILED DESCRIPTION

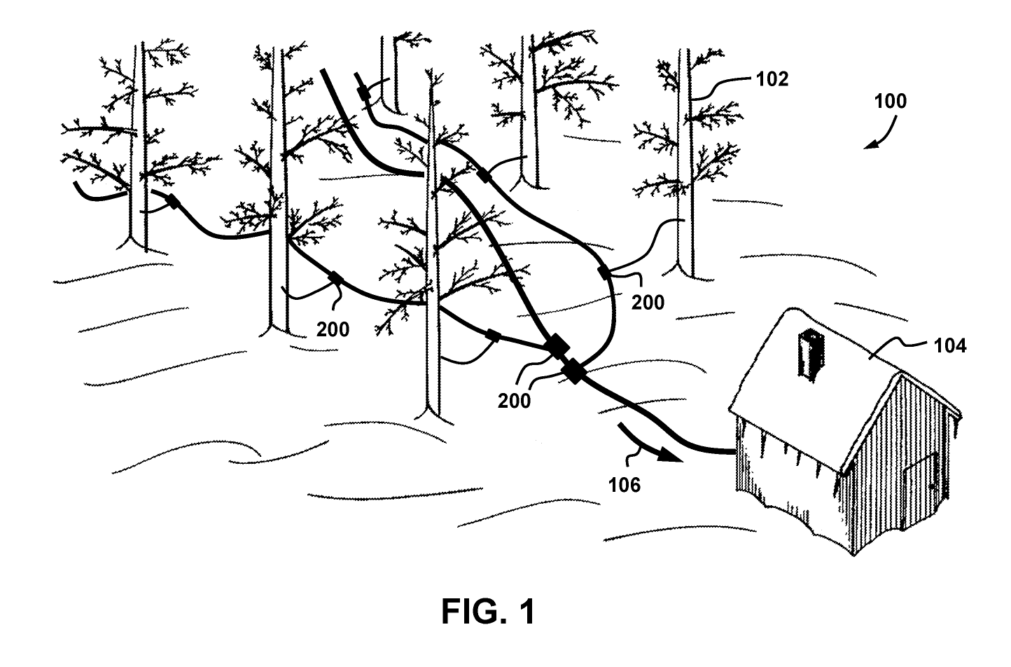

FIG. 1 is a semi-schematic view depicting a simplified example of a facility 100 for harvesting sap from trees 102. The sap is harvested at each tree using a spout. Each spout is connected to a tubing network of the facility 100 and that is provided to transport the sap towards a destination, for instance, as shown in FIG. 1, inside a building 104. The sap flows inside the tubing network from the numerous spouts located throughout the facility 100. The interior of the tubing is under a negative pressure, i.e. vacuum pressure, when harvesting sap to facilitate the flow towards the building 104 in addition to gravity. This negative pressure can be created using one or more pumps provided, for instance, inside the building 104 or at any other suitable location. The sap flows downstream in a general flow direction 106 and the inner diameter progressively increases towards the building 104. Once inside the building 104, the sap can go into a reservoir, a tank or any other suitable container. Other configurations and arrangements are possible.

It should be noted that the facility 100 depicted an example in FIG. 1 is very simplified. A sugar bush can include several thousand trees and an extensive tubing network. The building 104 would then be considerably bigger than that depicted in FIG. 1. However, the general principle remains the same.

The tubing network of the facility 100 in FIG. 1 includes a multitude of tube segments that are interconnected using various connectors 200. Unlike conventional connectors, these connectors 200 have heat-fused joints that are both airtight and solid. They do not require the use of collars or the like.

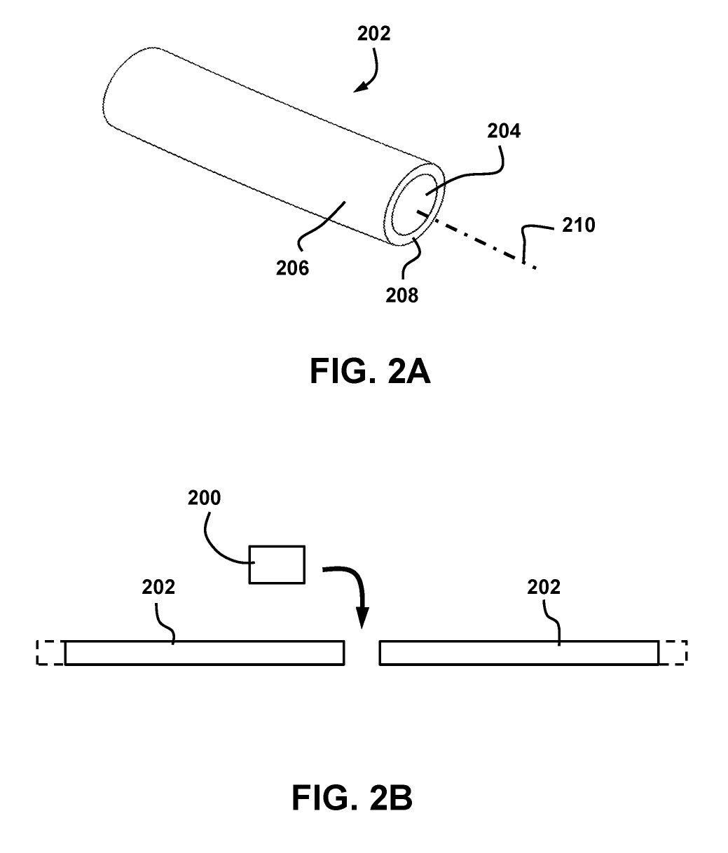

FIG. 2A is a semi-schematic view of a flexible thermoplastic tube segment 202. Tubes for harvesting sugar maple sap are generally made of polyethylene. Different types of polyethylene that is not cross-linked, such as low-density polyethylene, linear low-density polyethylene, medium density polyethylene, high-density polyethylene, to name just a few, can be used and different can be used. Other materials are possible as well, depending on the implementations. Various kinds of additives can be incorporated into the material used for manufacturing the tubes, depending on the desired properties, such as a greater resistance to traction, an enhanced resistance to UV rays, being less prone to cracking, etc. These tubes are generally transparent or translucent so that the liquid flowing therein can be seen. Variants are possible.

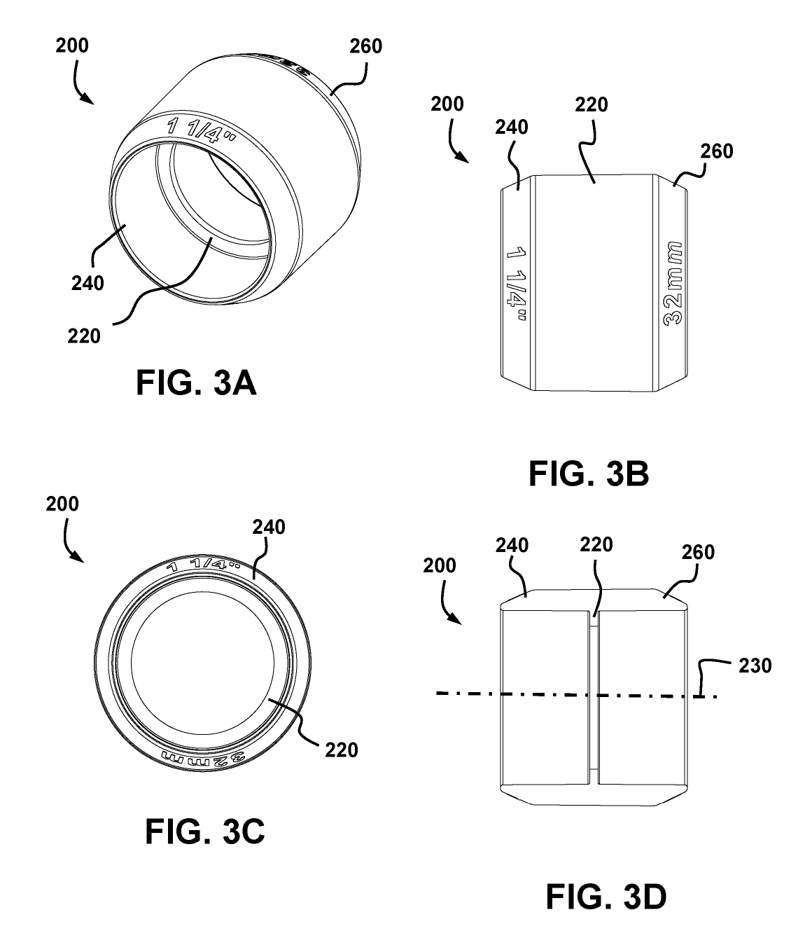

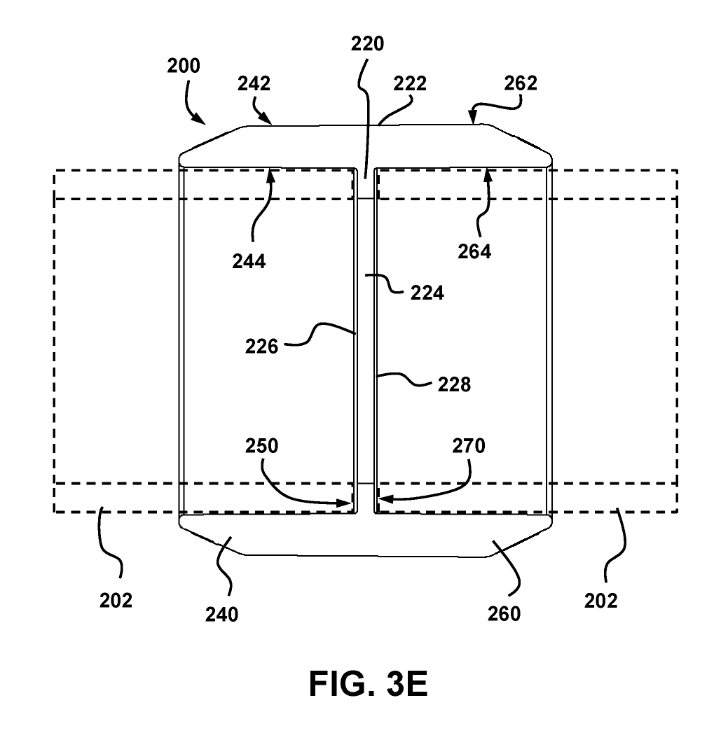

The tubes used for harvesting sap are often purchased on rolls to facilitate their transportation and handling. Each roll includes an extensive continuous tube and it is necessary to cut it into segments. The tube can be cut using, for instance, a manual tool having a rotating blade creating a groove increasing in depth after each rotation of the tool until it reaches the interior and the tube segment can be detached. Such tool is useful to create a cut that is truly perpendicular to the central longitudinal axis 230 (FIG. 3D) of the connector 200. Other tools or methods are possible as well.

The tube segment 202 depicted in FIG. 2A is only an example for the sake of illustration. The sidewall of the tube includes an inner surface 204 having an inner diameter, and an outer surface 206 having an outer diameter. The cut creates an annular end surface 208 that is substantially perpendicular to the central longitudinal axis 210 of the tube segment 202. The thickness of the sidewall can vary, depending on the material. For instance, tubes made of a low-density plastic material are often thicker than those made of a high-density plastic material. Variants are possible.

FIG. 2B is a semi-schematic isometric view of two tube segments 202 to be coupled using a connector 200. This connector 200 is an intervening piece provided to rigidly attach the downstream end of a first one of the tube segments 202 to the upstream end of a second one of the tube segments. This will form a tube segment assembly.

FIG. 3A is an isometric view of an example of a straight connector 200. The connector 200 of this example allows to join two tube segments 202 having the same dimensions. The connector 200 includes a central part 220 around which are provided two opposite receptacles 240, 260. Each receptacle 240, 260 allows to receive the end of a corresponding one of the tube segments 202.

FIG. 3B is a side view of the connector 200 in FIG. 3A. FIG. 3C is a front view of one of the receptacles 240, 260 of the connector 200 in FIG. 3A. FIG. 3D is a longitudinal cross-section view of the connector 200 in FIG. 3A and also shows that the connector 200 has a central longitudinal axis 230.

FIG. 3E is an enlarged view of what is shown in FIG. 3D. It also shows the relative position of the end of two tube segments 202 to be joined by this connector 200. As can be seen in FIG. 3E, the central part 220 of the connector 200 in this example is very short compared to the length of the receptacles 240, 260 along the central longitudinal axis 230. The central part 220 includes an outer surface 222 and an inner surface 224. The inner surface 224 is generally smooth and circular in cross-section. The central part 220 is longitudinally delimited by two opposite edges 226, 228, namely a first edge 226 and a second edge 228. The first edge 226 has an inner diameter and the second edge 228 also has an inner diameter. The two inner diameters are identical in the example, but other configurations and arrangements are possible in some implementations.

In the illustrated example, the first receptacle 240 is coaxially disposed on a side of the central part 220, namely the one that is adjacent to the first edge 226. This first receptacle 240 includes an outer surface 242 and an inner surface 244. The inner surface 244 is generally smooth and circular in cross-section. The inner surface 244 of the receptacle 240 has an inner diameter that is larger than that of the first edge 226. This creates a first annular inner surface 250 between the first edge 226 and the inner surface 244 of the first receptacle 240 where it reaches the central part 220. This first annular inner surface 250 is preferably perpendicular to the central longitudinal axis 230. Other configurations and arrangements are possible.

The second receptacle 260 in the illustrated example is coaxially disposed on another side of the central part 220, namely the one that is adjacent to the second edge 228. The second receptacle 260 includes an outer surface 262 and an inner surface 264. The inner surface 264 is generally smooth and circular in cross-section. The inner surface 264 of the second receptacle 260 also has an inner diameter than that of the second edge 228 to define a second annular inner surface 270 circumscribed between the second edge 228 and the inner surface 264 of the second receptacle 260 where it reaches the central part 220. This second annular inner surface 270 is preferably perpendicular to the central longitudinal axis 230. Other configurations and arrangements are possible.

The various parts are dimensioned so that the inner diameter of the inner surface 244 of the first receptacle 240 corresponds to the outer diameter of the outer surface 206 of the first tube segment 202. This allows its insertion therein and that its annular end surface 208 can abut against the first annular inner surface 250. Hence, the inner diameter of the inner surface 264 of the second receptacle 260 corresponds the outer diameter of the outer surface 206 of the second tube segment 202. This allows it to be inserted therein and its annular end surface 208 can abut against the second annular inner surface 270. Furthermore, the inner diameter of the first edge 226 corresponds to the inner diameter of the inner surface 204 of the first tube segment 202 when it is inserted into the first receptacle 240 and the inner diameter of the second edge 228 corresponds to the inner diameter of the inner surface 204 of the second tube segment 202 when it is inserted into the second receptacle 260. There is thus no gap or discontinuity once the joint is made.

The connector 200 is made of a thermoplastic material that can be heat fused, thereby allowing the merge the inner surface 244 of the first receptacle 240 to the outer surface 206 of the first tube segment 202 and to merge the inner surface 264 of the second receptacle 260 to the outer surface 206 of the second tube segment 202, and this, without creating a gap or an irregularity inside the portion of the liquid circuit and without using collars or the like on the outside. The joint is perfectly sealed on the entire perimeter, thereby preventing micro-leaks when operating at a negative pressure.

The outer surface 242, 262 of the receptacles 240, 260 can be generally parallel to the axis of the opening over most of their length. They are beveled near their ends. Other configurations and arrangements are possible.

If desired, the inner surface of the receptacles 240, 260 can be slightly flared to facilitate the insertion of the tube segment 202 in the corresponding receptacle 240, 260. The inner diameter near the outer edge is then slightly greater than that of the inner diameter at the bottom. The angle of the inner surfaces 244, 264 can be about 0.5 to 5.0 degrees. Other values are possible. This feature can also be omitted in some implementations.

The depth of each receptacle 240, 260 is preferably between 3 to 3.5 times the thickness of the corresponding tube segment 202. This allows obtaining a joint having a tensile strength of at least 2 to 2.5 times the strength of the tube segment. In other words, an excessive pulling force will damage the tube segment 202 before the junction provided by the connector 200 fails. Variants are possible.

It should be noted that the straight connector 200 with two receptacles of FIGS. 3A to 3E includes preferably an outer surface devoid of discontinuities. This can be useful, among other things, to minimize the friction between the connector 200 and the ground when the connector 200 is pulled by a vehicle or the like. The opposite ends of the receptacles 240, 260 are preferably beveled. Other configurations and arrangements are possible.

The connector 200 has sidewall thicknesses that are not too important in order to simplify the molding process. Thick parts should be avoided whenever possible since the plastic material could be prone to distortions during the cooling period right after the injection.

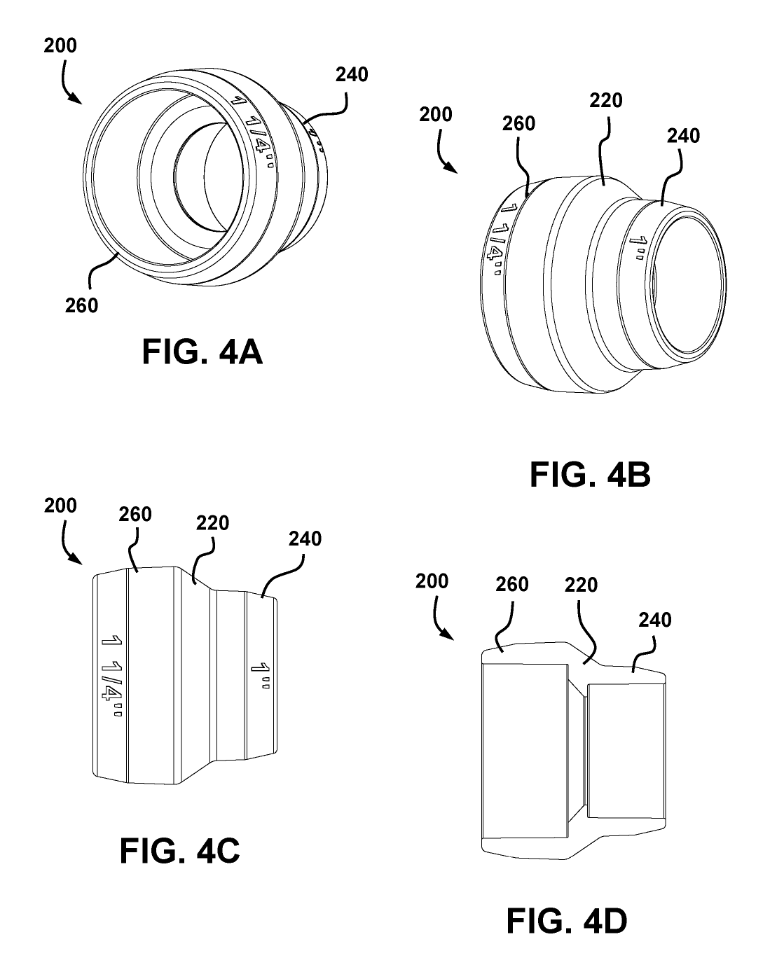

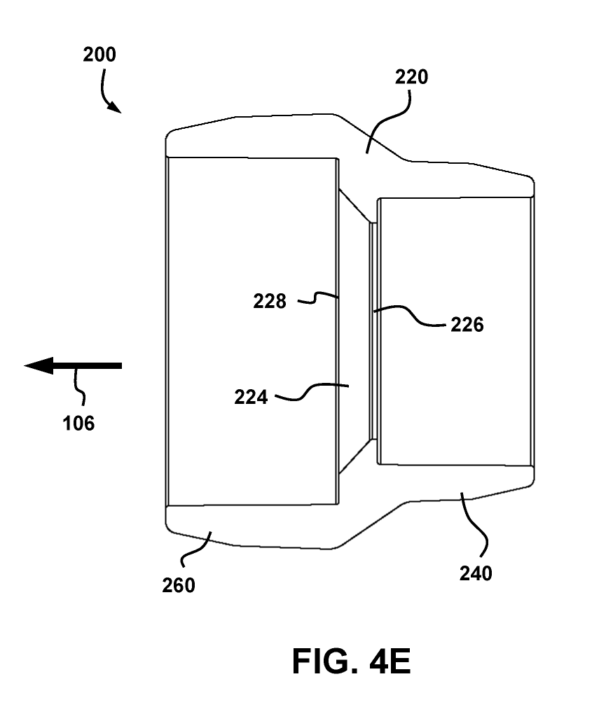

FIG. 4A is a first isometric view of another example of a straight connector 200. In this example, the two opposite receptacles 240. 260 have unequal inner diameters. This allows joining a first tube segment 202 to a second tube segment 202 of greater diameter.

FIG. 4B is a second isometric view of the connector 200 in FIG. 4A. FIG. 4C is a side view of the connector 200 in FIG. 4A. FIG. 4D is a longitudinal cross-section view of the connector 200 in FIG. 4A.

FIG. 4E is an enlarged view of what is shown in FIG. 4D. FIG. 4E shows, among other things, that the inner surface 224 of the central part 220 is conical between the two edges 226, 228.

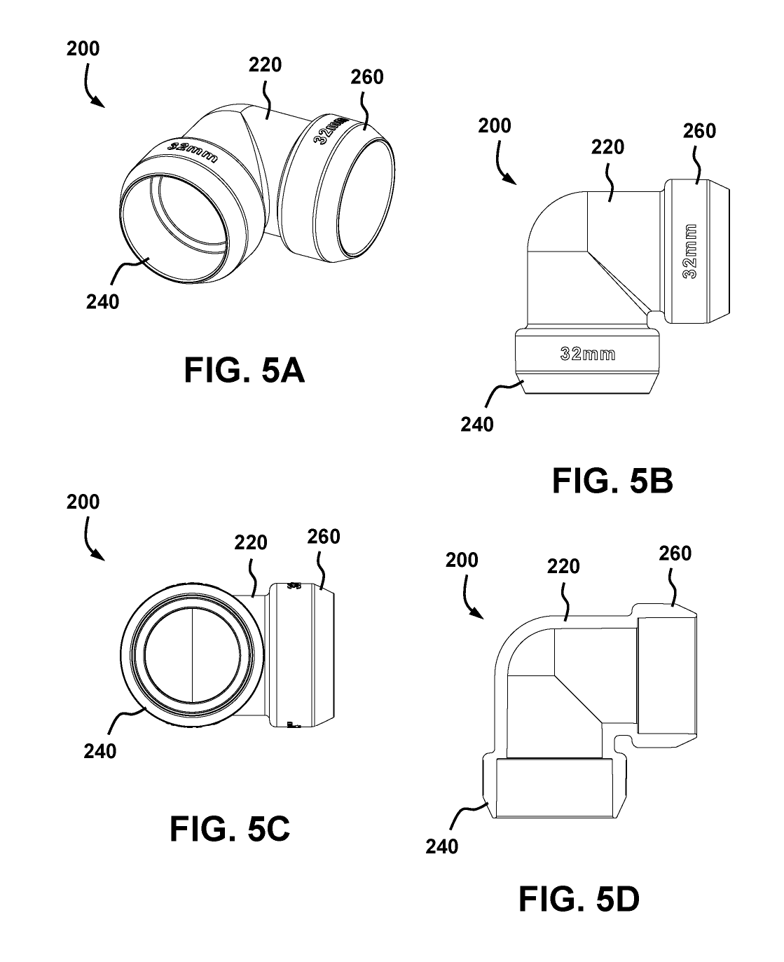

FIG. 5A is an isometric view of an example of the connector 200 with a 90-degree elbow. FIG. 5B is a side view of the connector 200 in FIG. 5A. FIG. 5C is a front view showing one of the receptacles of the connector 200 in FIG. 5A. FIG. 5D is a transversal cross-section view of the connector 200 in FIG. 5A.

It should be noted that the elbow connector like the one shown in the example of FIGS. 5A to 5D may have an angle that is not of 90 degrees. This angle can vary, for instance, between 15 and 90 degrees. Other angles, configurations and arrangements are possible.

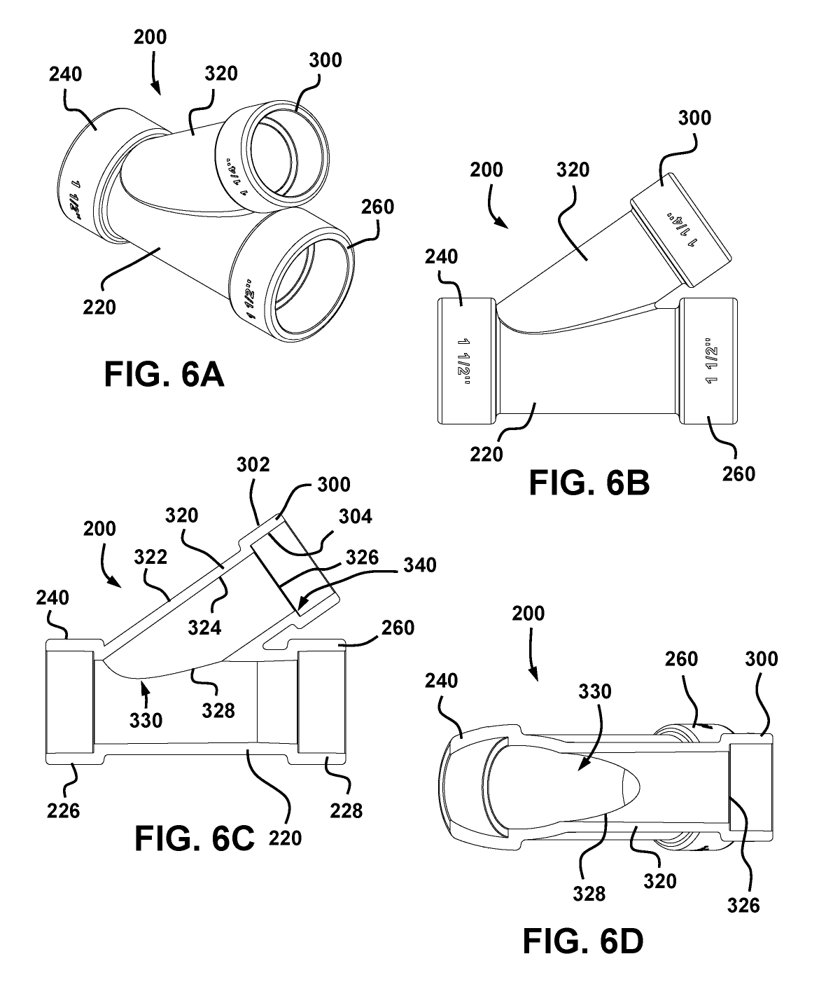

FIG. 6A is an isometric view of an example of a Y-shaped connector 200. This kind of connector 200 is generally used for linking a secondary tube to a master tube, for instance. Other implementations are possible as well.

FIG. 6B is a side view of the connector 200 in FIG. 6A. FIG. 6C is a longitudinal cross-section view of the connector 200 in FIG. 6A. FIG. 6D is an oblique transversal cross-section view of the connector 200 in FIG. 6A.

As can be seen, the Y-shaped connector 200 includes a third receptacle 300 for joining the ends of a third tube segment 202 to the ends of the first and second tube segments 202. This third tube segment 202 includes an inner surface 204 having an inner diameter, an outer surface 206 having an inner diameter and an annular end surface 208 that is substantially perpendicular to a central longitudinal axis 210 of the third tube segment 202.

The Y-shaped connector 200 also includes a lateral part 320 having an outer surface 322 and an inner surface 324. The inner surface 324 is generally smooth and circular in cross-section. The lateral part 320 is delimited by two opposite edges 326, 328, one of these edges being a third edge 326 having an inner diameter and the other of these two edges being a fourth edge 328 bordering a lateral opening 330 made along the central part 220 between the first and second edges 226, 228.

The third receptacle 300 is coaxially disposed at the end of the lateral part 320 that is adjacent to the third edge 326 326. The third receptacle 300 includes an outer surface 302 an inner surface 304. This inner surface 304 is generally smooth and circular in cross-section. The inner surface 304 of the third receptacle 300 has an inner diameter greater than that of the third edge 326 to define a third annular inner surface 340 that is radially circumscribed between the third edge 326 and the inner surface 304 of the third receptacle 300. Other configurations and arrangements are possible.

In this implementation, the inner diameter of the inner surface 304 of the third receptacle 300 corresponds to the outer diameter of the outer surface 206 of the third tube segment 202 so that it can be inserted therein and that its annular end surface 208 can abut against the third annular inner surface 340. The inner diameter of the third edge 326 corresponds to the inner diameter of the inner surface 204 of the third tube segment 202 when it is inserted into the third receptacle 300.

The thermoplastic material for the connector 200 allows, through heat fusion, to fuse the inner surface 304 of the third receptacle 300 to the outer surface 206 of the third tube segment 202, and this, without creating a gap or an irregularity inside the portion of the liquid circuit.

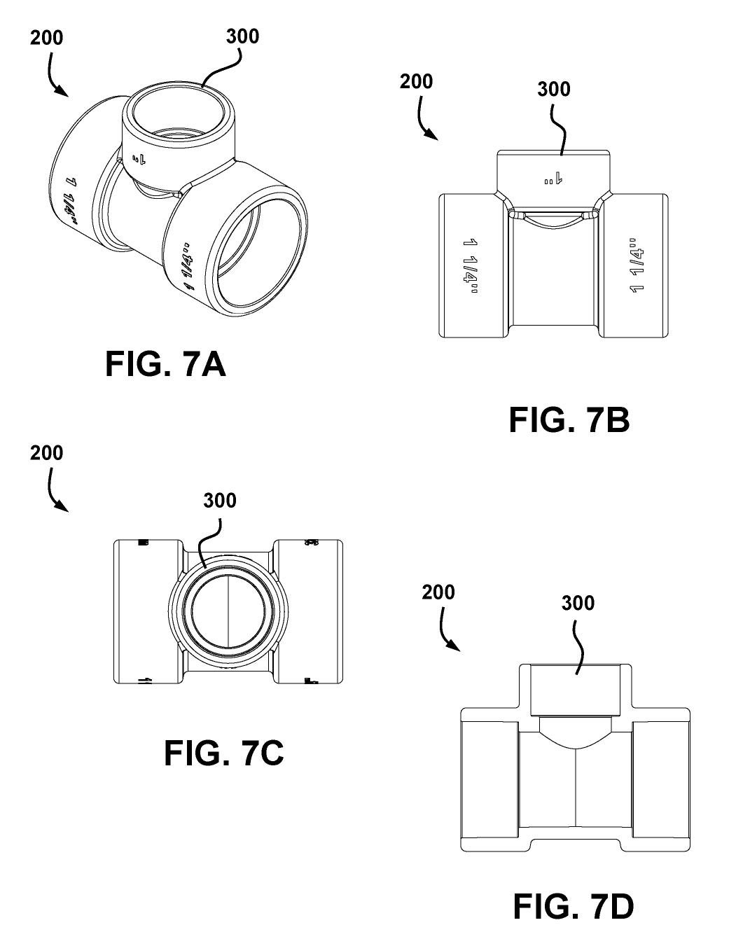

FIG. 7A is an isometric view of an example of a T-shaped connector 200. FIG. 7B is a side view of the connector 200 in FIG. 7A. FIG. 7C is a top view of the connector 200 in FIG. 7A. FIG. 7D is a longitudinal cross-section view of the connector 200 in FIG. 7A.

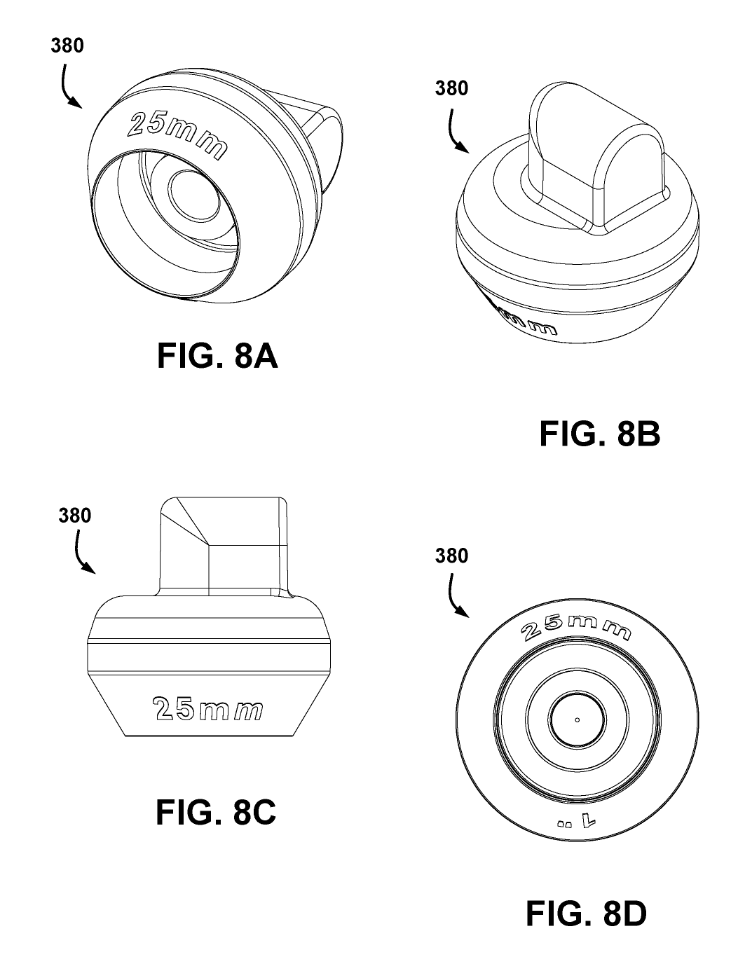

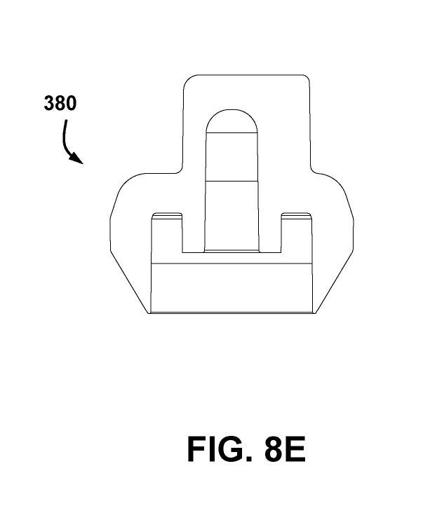

FIG. 8A is a first isometric view of an example of an end plug 380. This plug 380 allows closing the free end of a tube segment 202 at the upstream end. The plug 380 is a specialized kind of connector. The joint between the tube segment 202 and the plug 380 is created the same way the other joints were created. The plug 380 can be made of a thermoplastic material.

The plug 380 can include an opening for a pressure gage used for measuring the relative pressure between the interior of the tubing network and the ambient air. Other variants are possible as well.

FIG. 8B is a second isometric view of the plug 380 in FIG. 8A. FIG. 8C is a side view of the plug 380 in FIG. 8A. FIG. 8D is a front-end view of the plug 380 in FIG. 8A. FIG. 8E is a longitudinal cross-section view of the plug 380 in FIG. 8A.

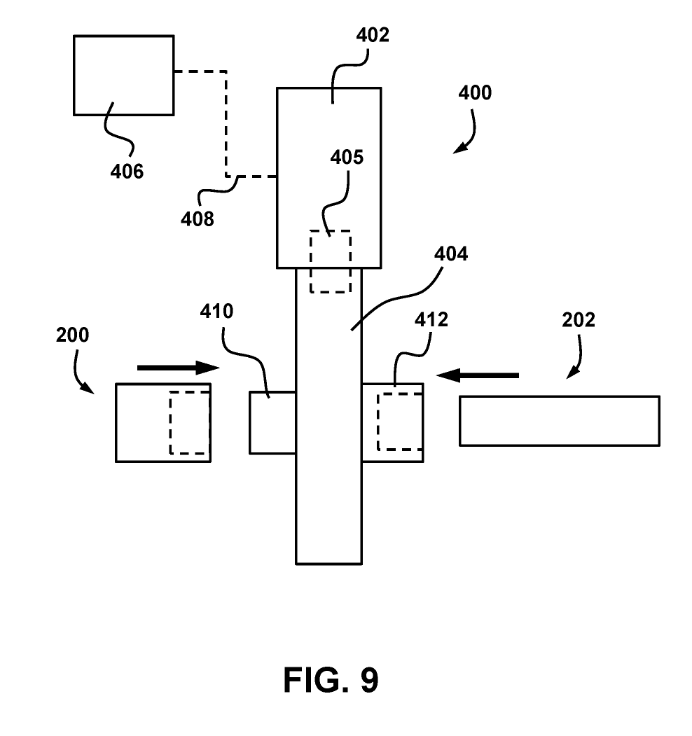

FIG. 9 is a semi-schematic view of a portable apparatus 400 for coupling the ends of two thermoplastic tube segments. In this example, the apparatus 400 includes a base 402 that can be handheld. The base 402 can also include control buttons, among other things. The base 402 can be connected to a metallic plate 404 to transfer heat to other parts. Different arrangements are possible for generating the heat. In the illustrated example, one or more electric heating elements 405 are provided. The metallic plate 404 is preferably vertically oriented in use but variants are possible. The energy can be provided by an energy source 406. A power cable 408 can be provided when the source 406 supplies electrical energy and in this case, the source 406 can be an electrical outlet linked to a power network. When used in a sugar bush, the source 406 can be a generator, a portable battery or a power outlet on a vehicle. Other energy sources and heating arrangements are possible, including ones where heat is not generated or entirely generated using electricity. For instance, heat can be produced at a burner through the combustion of a gas or liquid fuel, such as propane. Other configurations, arrangements and materials are possible.

At least two metallic dies 410, 412 on each side of the metallic plate 404. These dies 410, 412 have a shape resembling that of a cup. One of the dies is a male die 410 having an outer surface 414 capable of transferring heat to the inner surfaces 244, 264, 304 of the corresponding receptacles 240, 260, 300. The other is a female die 412 having an inner surface 416 capable of transferring heat to the outer surface 206 at the end of the tube segment 202. The two dies 410, 412 are connected opposite to one another on the metallic plate 404, for instance using a screw or any other suitable means. The dies 410, 412 allow heating the plastic parts uniformly on their entire perimeter. Several sizes and models of dies can be transported and installed on the apparatus 400 in function of the needs. The apparatus 400 can also be designed such that several pairs of dies can be used simultaneously.

In use, the plastic parts to be heated are inserted in the dies 410, 412 by the worker. The worker holds each part in one hand. One is then at the left and the other at the right. The parts are maintained in position until the sidewall surfaces to be joined are at the adequate temperature, this taking only a few seconds, for instance about 4 seconds. The parts are withdrawn from the dies 410, 412 and the end of the tube segment 202 is immediately inserted up to the bottom of the receptacle of the corresponding connector 200 that is simultaneously heated. The parts are maintained together until the plastic material has cooled and solidified, this occurring very quickly. The joint is then complete and can be used immediately.

It should be noted that the annular end surface 208 as well as the corresponding annular inner surfaces 250, 270, 340 are preferably not in contact with the dies 410, 412 during heating. This prevents a snag, namely an annular leftover caused by molten plastic that was pushed toward the interior at the time the two annular surfaces come in contact with one another. Hence, when heating the parts, the worker does not insert the parts completely up to bottom of the dies.

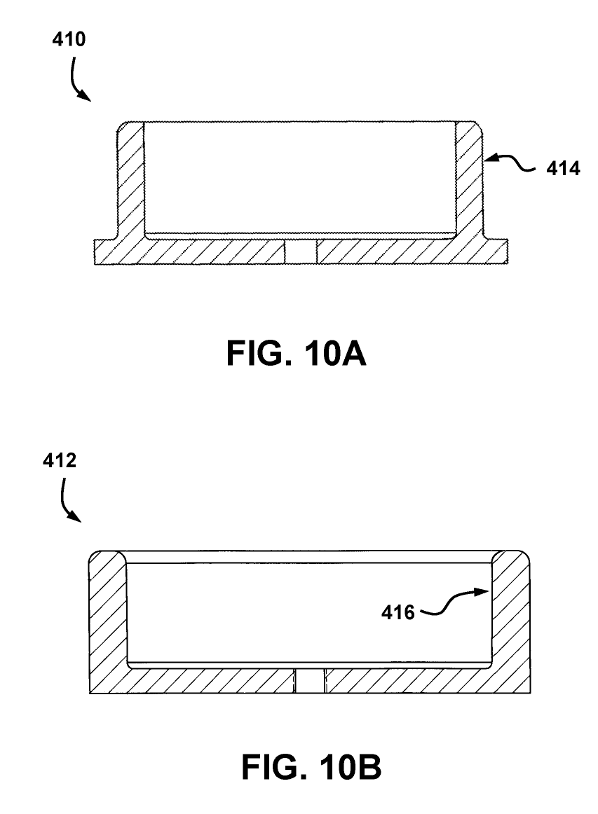

FIG. 10A is a cross-section view of an example of a male die 410 provided on the apparatus 400 for heating the inner surface of one of the receptacles of the connector 200. FIG. 10B is a cross-section view of an example of a female die 412 provided on the apparatus 400 for heating the outer surface of the end of the tube segment 202. The holes at the bottom are for receiving holding screws.

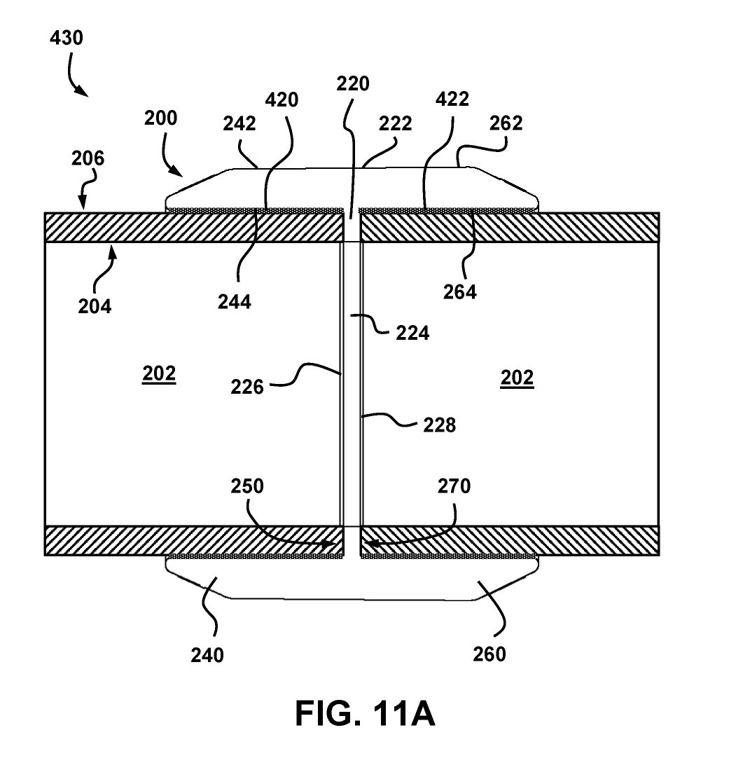

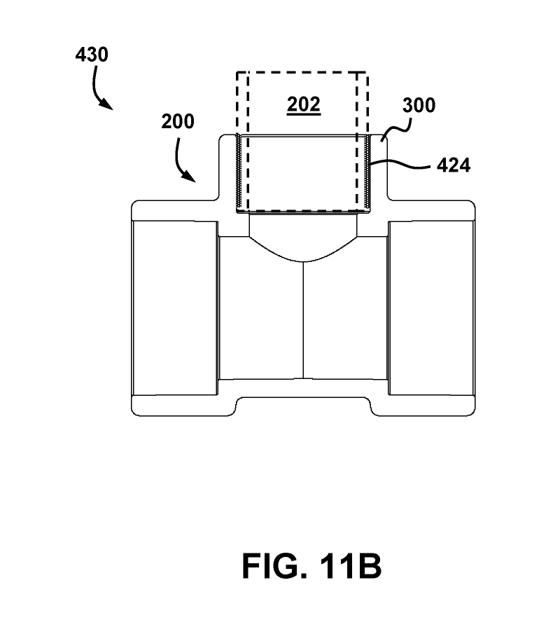

FIG. 11A is a cross-section view of an example of a tube segment assembly 430 in which a first and a second tube segment 202 are rigidly coupled through an intervening connector 200. The tube segment assembly 430 includes a first heat-fused joint 420 in the first receptacle 240 and a second heat-fused joint 422 in the second receptacle 260.

FIG. 11B is a semi-schematic view in which a third tube segment 202 is rigidly attached to the connector 200 of FIG. 7D. This connector 200 includes a third receptacle 300 and the third tube segment 202 is heat fused therein using a third heat-fused joint 424. It should be noted that the first and second tube segments are not visible in the tube segment assembly 430 depicted in FIG. 11B only for the sake of simplicity.

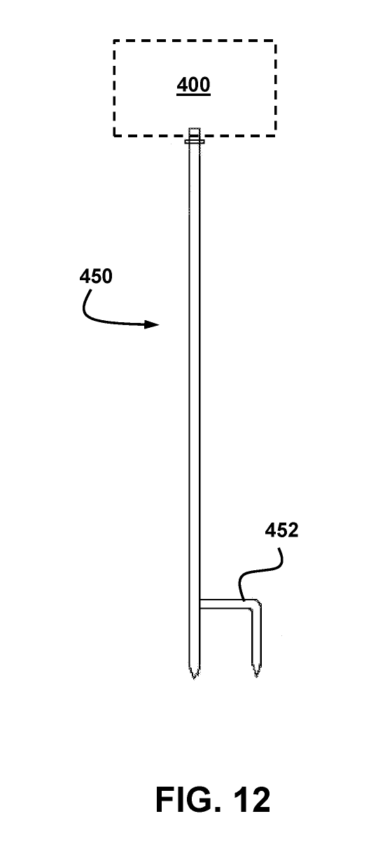

FIG. 12 is a side view of an example of a stand 450 for the portable apparatus 400. The support is an optional element that can be useful for keeping the apparatus 400 at the right position without the need for the worker to hold it with a hand. The support alleviates the need of putting the apparatus 400 on the ground, thereby greatly minimizing the risks of contact with snow or water.

Various kinds of supports can be used. In the example, the stand 450 includes an elongated vertical post and its top end can be inserted in a corresponding hole made underneath the apparatus 400.

This configuration also allows pivoting the apparatus 400 around a pivot point over at least 180 degrees, which can be useful for easily inverting the left-right position of the dies 410, 412. Other configurations and arrangements are possible.

A locking mechanism may be provided to prevent the apparatus 400 from being detached. Other implementations are possible. For instance, it is also possible to support the apparatus 400 from above, hence that the apparatus 400 is suspended. Other variants are possible as well.

The stem of the stand 450 in the example of FIG. 12 includes a pointed bottom end to facilitate the insertion into most types of forest soils. It also includes an inverted L-shaped lateral part 452 allowing, among other things, the stem to be inserted when pushed by a foot or using a tool such as a hammer. The lateral part 452 can also be useful to withdraw the stem by pulling it using a tool. This lateral part 452 can be omitted in some implementations, and other variants are possible.

Another implementation for the support is a stem or another kind of structure that can be attached to a vehicle, for instance an ATV, or above a power generator. Other variants are possible as well.

The present detailed description and the appended figures are meant to be exemplary only, and a skilled person will recognize that variants can be made in light of a review of the present disclosure without departing from the proposed concept.

### REFERENCE NUMERALS

100 facility
102 tree
104 building
106 flow direction
200 connector
202 tube segment
204 inner surface (tube segment)
206 outer surface (tube segment)
208 annular end surface
210 central longitudinal axis (tube segment)
220 central part (connector)
222 outer surface (central part)
224 inner surface (central part)
226 first edge (central part)
228 second edge (central part)
230 central longitudinal axis (connector)
240 first receptacle
242 outer surface (first receptacle)
244 inner surface (first receptacle)
250 first annular inner surface
260 second receptacle
262 outer surface (second receptacle)
264 inner surface (second receptacle)
270 second annular inner surface
300 third receptacle
302 outer surface (third receptacle)
304 inner surface (third receptacle)
320 lateral part (third receptacle)
322 outer surface (third receptacle)
324 inner surface (third receptacle)
326 third edge
328 fourth edge
330 lateral opening
340 third annular inner surface
380 plug
400 apparatus
402 base
404 metallic plate
405 heating element
406 energy source
408 power cable
410 male die
412 female die
414 outer surface (male die)
416 inner surface (female die)
420 first heat-fused joint
422 second heat-fused joint
424 third heat-fused joint
430 tube segment assembly
450 stand
452 lateral part

What is claimed is:

1. A tube segment assembly (430) including:
a first flexible thermoplastic tube segment (202) having an upstream end and a downstream end;
a second flexible thermoplastic tube segment (202) having an upstream end and a downstream end;
an intervening thermoplastic connector (200) having a central longitudinal axis (230), the connector (200) including:
a central part (220) having an outer surface (222) and an inner surface (224) that are generally smooth and circular in cross-section, the central part (220) being longitudinally delimited by opposite first and second edges (226, 228), the first edge (226) having an inner diameter and the second edge (228) having an inner diameter;
a first receptacle (240) coaxially disposed with reference to a side of the central part (220) that is adjacent to the first edge (226), the first receptacle (240) including a generally smooth inner surface (244) having an inner diameter that is larger than that of the first edge (226) to define a first annular inner surface (250); and
a second receptacle (260) coaxially disposed on another side of the central part (220) that is adjacent to the second edge (228), the second receptacle (260) including a generally smooth inner surface (264) having an inner diameter that is larger than that of the second edge (228) to define a second annular inner surface (270);
wherein:
the first tube segment (202) has an inner surface (204) and an outer surface (206), the inner surface (204) of the first tube segment (202) having an inner diameter corresponding to the inner diameter of the first edge (226) of the central part (210), the outer surface (206) of the first tube segment (202) having an outer diameter corresponding to the inner diameter of the inner surface (244) of the first receptacle (240), the outer surface (206) at the downstream end of the first tube segment (202) being heat fused with the inner surface (244) of the first receptacle (240) at a first heat-fused joint (420); and
the second tube segment (202) has an inner surface (204) and an outer surface (206), the inner surface (204) of the second tube segment (202) having an inner diameter corresponding to the inner diameter of the second edge (228) of the central part (210), the outer surface (206) of the second tube segment (202) having an outer diameter corresponding to the inner diameter of the inner surface (264) of the second receptacle (260), the outer surface (206) at the upstream end of the second tube segment (202) being heat fused with the inner surface (264) of the second receptacle (260) at a second heat-fused joint (422).

2. The tube segment assembly (430) according to claim 1, wherein:
the first tube segment (202) has an annular end surface (208) that is substantially perpendicular to the central longitudinal axis (230) and abuts against the first annular inner surface (250), and
the second tube segment (202) has an annular end surface (208) that is substantially perpendicular to the central longitudinal axis (230) and abuts against the second annular inner surface (270).

3. The tube segment assembly (430) according to claim 1, wherein:
the tube segment assembly (430) further includes a third tube segment (202) having an upstream end and a downstream end; and
the connector (200) further includes a third receptacle (300) laterally disposed on the connector (200), the third receptacle (300) including an inner surface (304) and a third annular inner surface (340);
wherein:
the third tube segment (202) has an inner surface (204) and an outer surface (206), the outer surface (206) of the third tube segment (202) having an outer diameter corresponding to the inner diameter of the inner surface (304) of the third receptacle (300), the outer surface (206) at the downstream end of the third tube segment (202) being heat fused with the inner surface (304) of the third receptacle (240) at a third heat-fused joint (424).

4. The tube segment assembly (430) according to claim 3, wherein the connector (200) further includes a lateral part (320) extending between the central part (310) and the third receptacle (300), the lateral part (320) having a generally smooth inner surface (324) delimited by a third edge (326) having an inner diameter and by a fourth edge (328) bordering a lateral opening (330) provided along the central part (220) between the first and second edges (226, 228), the inner surface (204) of the third tube segment (202) having an inner diameter corresponding to the inner diameter of the third edge (226).

5. The tube segment assembly (430) according to claim 4, wherein the lateral part (320) is disposed at right angle with reference to the central part (220).

6. The tube segment assembly (430) according to claim 4, wherein the lateral part (320) is disposed with an acute angle with reference to the central part (220).

7. The tube segment assembly (430) according to claim 1, wherein the outer diameter of the outer surface (222) of the central part (220) is smaller than the outer diameter of the outer surface (242, 262) of at least one among the first and second receptacles (240, 260).

8. The tube segment assembly (430) according to claim 1, wherein the first annular inner surface (250) and the second annular inner surface (270) are perpendicular to the central longitudinal axis (230).

9. The tube segment assembly (430) according to claim 1, wherein the inner surface (244, 264) of at least one of the receptacles (240, 260) is flared out of about 0.5 to 5.0 degrees.

10. The tube segment assembly (430) according to claim 1, wherein each tube segment (202) has a thickness and each receptacle (240, 260) has a depth that is at least 3 times the thickness of a corresponding one of the tube segments (202).

11. The tube segment assembly (430) according to claim 1, wherein the connector (200) and the tube segments (202) are made of polyethylene.

12. A method of joining corresponding ends of flexible thermoplastic tube segments (202) using an intervening thermoplastic connector (200) having at least two receptacles (240, 260), the method including:
generating heat on a portable apparatus (400);
transferring the generated heat to a male die (410) provided on the apparatus (400);
transferring the generated heat to a female die (412);
inserting the male die (410) in a corresponding one of the receptacles (240, 260) for surface heating an inner surface (244, 264) to a temperature close to the melting point of the thermoplastic;
inserting the end of one of the tube segments (202) into the female die (412) for surface heating an outer surface (206) of the corresponding tube segment (202) to a temperature close to the melting point of the thermoplastic;
moving away the heated receptacle (240, 260) and the heated end of the corresponding tube segment (202) from the dies (410, 412), then inserting them into one another until an annular end surface (208) of the corresponding tube segment (202) abuts against an annular inner surface (250, 270) of the heater receptacle (240, 260); and then
cooling the heated receptacle (240, 260) and the heated end of the corresponding tube segment (202) until a heat-fused joint (420, 422) is formed.
